(19) United States
(12) Patent Application Publication
(10) Pub. No.: US 2008/0092131 A1
(43) Pub. Date: Apr. 17, 2008

(54) CENTRALIZED MANAGEMENT OF HUMAN MACHINE INTERFACE APPLICATIONS IN AN OBJECT-BASED SUPERVISORY PROCESS CONTROL AND MANUFACTURING INFORMATION SYSTEM ENVIRONMENT

(75) Inventors: James Paul McIntyre, San Jose, CA (US); Rashesh C. Mody, San Clemente, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems, Inc., Foxboro, MA (US)

(21) Appl. No.: 11/549,852

(22) Filed: Oct. 16, 2006

(51) Int. Cl. G06F 9/44

(52) U.S. Cl. 717/172

(57) ABSTRACT

A system is disclosed for facilitating centralized management of human machine interface (HMI) components distributable across multiple nodes of the system. The system includes a centralized configuration storage for managing a set of HMI templates deployable to a set of remote nodes including HMI facilities. The deployed HMI instances are thereafter executed upon the remote nodes. An HMI application import utility receives HMI applications that are not in a form suitable for management in the centralized configuration storage facility. the import utility encapsulates the received HMI applications to render the HMI templates that are suitable for the centralized configuration storage facility.

### TECHNICAL FIELD

The present invention generally relates to the field of networked computerized industrial control and automation systems. More particularly, the present invention relates to supervisory level control and manufacturing information systems. Such systems generally execute above a regulatory control layer in a process control system to provide guidance to lower level control elements such as, by way of example, programmable logic controllers or distributed control systems (DCSs). Such systems are also employed to acquire and manage historical information relating to such processes and their associated output.

### BACKGROUND

Industry increasingly depends upon highly automated data acquisition and control systems to ensure that industrial processes are run efficiently and reliably while lowering their overall production costs. Data acquisition begins when a number of sensors measure aspects of an industrial process and report their measurements back to a data collection and control system. Such measurements come in a wide variety of forms. By way of example the measurements produced by a sensor/recorder include: a temperature, a pressure, a pH, a mass/volume flow of material, a counter of items passing through a particular machine/process, a tallied inventory of packages waiting in a shipping line, cycle completions, etc. Often sophisticated process management and control software examines the incoming data associated with an industrial process, produces status reports and operation summaries, and, in many cases, responds to events/operator instructions by sending commands to actuators/controllers that modify operation of at least a portion of the industrial process. The data produced by the sensors also allow an operator to perform a number of supervisory tasks including: tailor the process (e.g., specify new set points) in response to varying external conditions (including costs of raw materials), detect an inefficient/non-optimal operating condition and/or impending equipment failure, and take remedial action such as move equipment into and out of service as required.

Typical industrial processes are extremely complex and receive substantially greater volumes of information than any human could possibly digest in its raw form. By way of example, it is not unheard of to have thousands of sensors (analog/digital) and control elements (e.g., valve actuators, motors, etc.) monitoring/controlling aspects of a multi-stage process within an industrial plant. The sensors are of varied type and report on varied characteristics of the process. Their outputs are similarly varied in the meaning of their measurements, in the amount of data sent for each measurement, and in the frequency of their measurements. As regards the latter, for accuracy and to enable quick response, some of these sensors/control elements take one or more measurements every second. When multiplied by thousands of sensors/control elements, the large number of periodic readings results in so much data flowing into the control and manufacturing information management system that sophisticated data management and process visualization techniques/applications are required.

Highly advanced human-machine interface/process visualization systems exist today that are linked to data sources such as the above-described sensors and controllers. Such systems acquire and digest (e.g., filter) the process data described above. The digested process data in-turn drives visualization applications rendering/presenting graphical views of the process for observation by human operators. An example of such system is the well-known Wonderware IN-TOUCH® human-machine interface (HMI) software system for visualizing and controlling a wide variety of industrial processes and manufacturing information. An IN-TOUCH® HMI process visualization application includes a set of graphical views of a particular process and its physical output. Each view, in turn, comprises one or more graphical elements. The graphical elements are potentially “animated” in the sense that their display state changes over time in response to associated/linked data sources. For example, a view of a refining process potentially includes a tank graphical element. The tank graphical element has a visual indicator showing the level of a liquid contained within the tank, and the level indicator of the graphical element rises and falls in response to a steam of data supplied by a tank level sensor indicative of the liquid level within the tank. Animated graphical images driven by constantly changing process data values within data streams, of which the tank level indicator is only one example, are considerably easier for a human observer to comprehend than a steam of numbers. Graphical images provided by HMI applications are also used to depict, and facilitate modifying, current process set points. For this reason process visualization systems, such as IN-TOUCH, have become essential components of supervisory process control and manufacturing information systems.

In known IN-TOUCH® application environments, the task of designing/developing HMI applications and the task of distributing such applications to remote computers on a network were performed via distinct and independent services/utilities. HMI applications, including associated graphical elements and links to process/production data sources, are initially created in a design environment (e.g., Wonderware's WINDOWMAKER). The WINDOWMAKER HMI application design environment enables a user to edit a single HMI application in a standalone environment on a single computing machine. Thereafter, copies of the HMI application are distributable to a set of networked machines using a known Network Application Distribution (NAD) service. The distribution scheme under which the NAD operates is separately defined and managed from the HMI application design/development environment. Thus, a programmer/developer of an INTOUCH HMI application cannot designate/control distribution of a new/updated HMI application from the design environment (i.e., there is no mechanism for determining what machines/stations are affected by the update).

In the known INTOUCH HMI application development environment, each HMI application stands on its own. An HMI application designer has access to a library of symbols (graphical elements) for creating an HMI display. However, once added to an HMI application, the symbols are owned solely by the HMI application. Thus, changing a particular graphical element's appearance in the HMI application is isolated within the particular application and has no effect on other HMI applications including instances of the same graphical element.

### SUMMARY OF THE INVENTION

The present invention addresses the potential need to provide better ways of managing HMI applications in a distributed network of HMI user nodes.

The above advantages are facilitated by a system for facilitating centralized management of human machine interface (HMI) components distributable across multiple nodes of the system. The system includes a centralized configuration storage for managing a set of HMI templates deployable to a set of remote nodes including HMI facilities. The deployed HMI instances are thereafter executed upon the remote nodes. An HMI application import utility receives HMI applications that are not in a form suitable for management in the centralized configuration storage facility. The import utility encapsulates the received HMI applications to render the HMI templates that are suitable for the centralized configuration storage facility.

Other inventive aspects of the systems and methods disclosed herein include symbol templates that are incorporated into the HMI templates and are managed as part of the centralized configuration storage. As a result, changes to the symbols templates are automatically propagated to the object templates within which they are embedded.

Furthermore the system supports status graphics that are displayed along-side the HMI templates to indicate their status in the managed configuration storage.

Finally, the system also includes an ability to import standalone HMI applications, edit them in an IDE environment, and thereafter export them to the standalone HMI application environment.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram depicting an exemplary supervisory process control network including a multi-layered supervisory process control and manufacturing information application including a set of personal computers having view engines and associated human-machine interface (HMI) application objects;

FIG. 2 depicts a multi-tiered object hosting arrangement for hosting applications on platforms and engines within an exemplary system embodying the present invention;

FIG. 3 depicts an exemplary set of attributes for a view engine object custom primitive;

FIG. 4 depicts an exemplary set of attributes for an HMI application object custom primititve;

FIG. 5a summarizes a set of relations between HMI application object templates/instances and embeddable symbol templates;

FIG. 5b depicts a sequence of stages associated with a symbol template, including propagating changes to the symbol template to HMI application templates within which the changed symbol template is embedded; and

FIG. 6 summarizes a set of functions that are potentially performed on an HMI application template.

### DETAILED DESCRIPTION OF THE DRAWINGS

The following description is based on embodiments of the invention and should not be taken as limiting the invention with regard to alternative embodiments that are not explicitly described herein. By way of example, the present invention is incorporated within a supervisory process control and manufacturing information application development and runtime environment wherein individual data sources (e.g., process equipment and associated logic) are represented by application objects. An example of such system is described in detail in Resnick et al., U.S. application Ser. No. 10/179,668 filed on Jun. 24, 2002, for SUPERVISORY PROCESS CONTROL AND MANUFACTURING INFORMATION SYSTEM APPLICATION HAVING A LAYERED ARCHITECTURE, the contents of which are incorporated herein by reference in their entirety including the contents and teachings of any references identified/contained therein. However, as those skilled in the art will appreciate in view of the disclosed exemplary embodiments, the present invention is potentially applicable to a variety of alternative supervisory process control and manufacturing information application development and runtime environments.

The disclosure herein is directed primarily to an infrastructure and related methods for centrally managing HMI applications (e.g., INTOUCH applications) within a supervisory process control and manufacturing information application environment comprising potentially many networked HMI nodes running separate instances of a previously defined HMI application. The disclosure includes a description of an HMI application encapsulated within a reusable HMI application template. Thereafter, HMI application objects are instantiated from the HMI application template and installed on a designated networked HMI node.

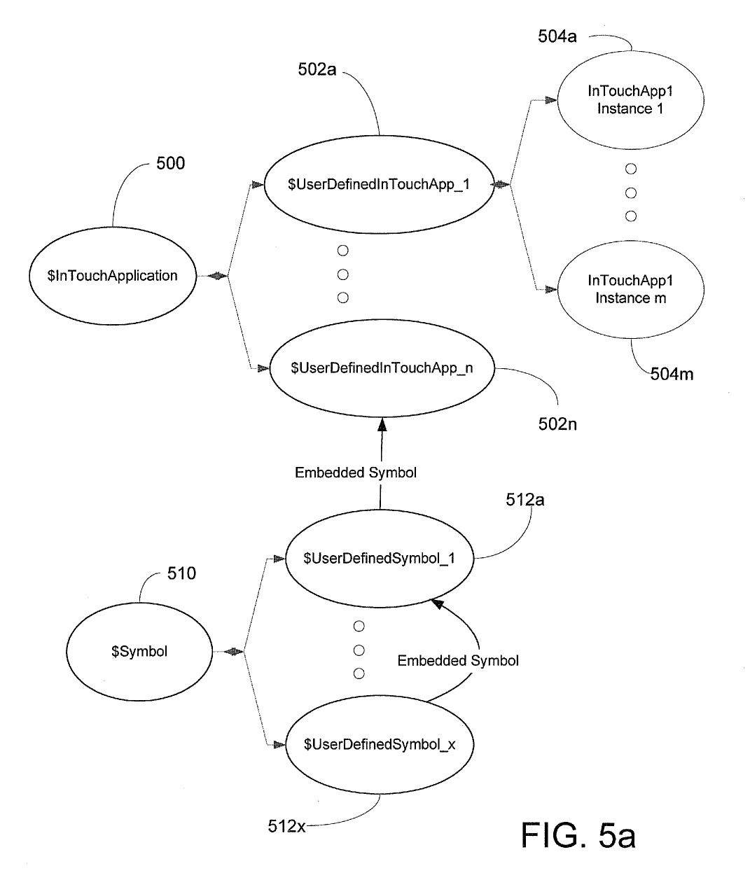

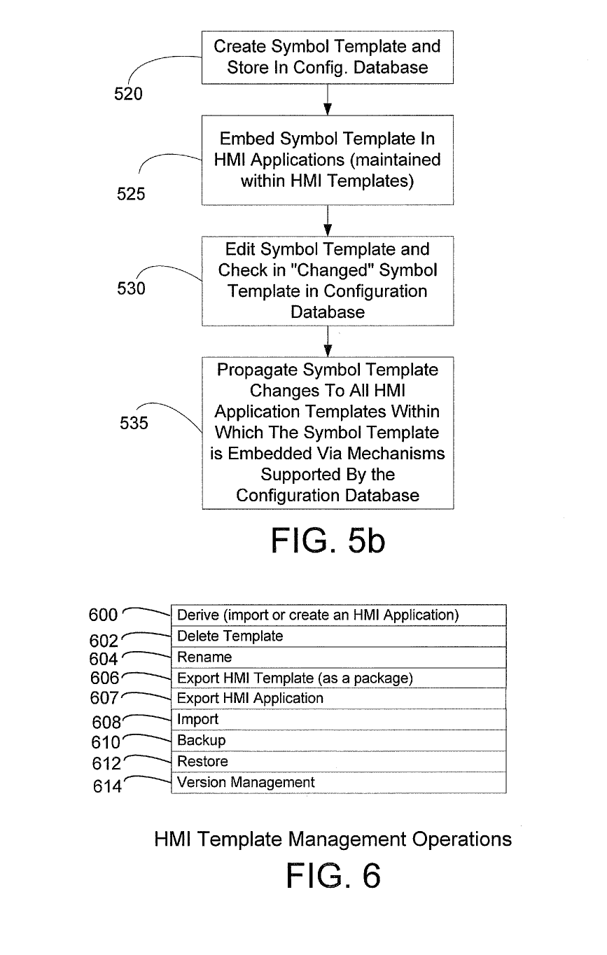

A second aspect of centrally managing HMI applications disclosed herein relates to propagating changes to symbols making up a portion of the graphics of an HMI application template into a set of HMI application object templates. By way of example, a symbol template is globally defined outside the HMI application. The symbol graphics are incorporated into HMI application templates via a reference to the centrally managed symbol template. The use of symbol templates to define symbol graphics for HMI applications facilitates propagating changes (using the aforementioned cross-reference lists) to the symbol templates down to all child symbol templates as well as all HMI application templates that incorporate by reference the changed original and derived child symbol templates. Such relationships and propagation paths are described further herein below with reference to FIG. 5.

A third aspect of centrally managing HMI applications disclosed herein relates to maintaining and graphically presenting a status for HMI objects in various views (e.g., deployment, derivation, model, etc.) of the contents of the configuration database 124 via the IDE 126. Examples of current status include: checked in/out, deployed/undeployed, and changed. Each of these exemplary statuses enables users to make decisions with regard to distributing instances of an HMI application.

Yet another aspect of the disclosed central management arrangement is the ability of users to edit an existing HMI application definition (template) from a remotely deployed configuration tool such as an Integrated Development Environment (IDE) facility.

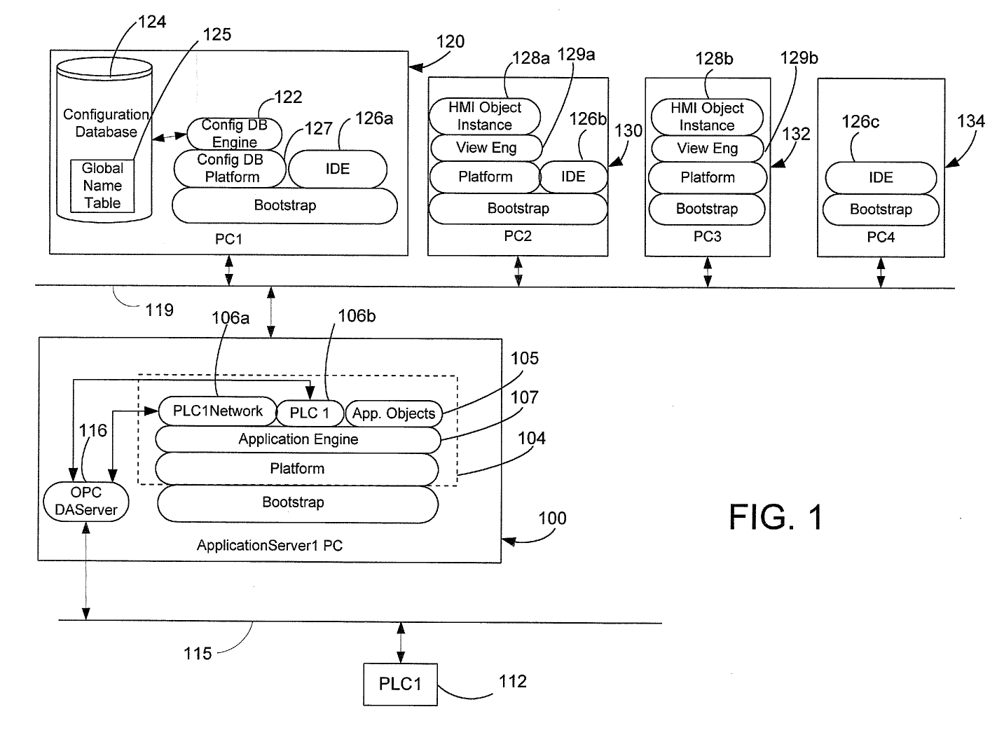

Referring to FIG. 1, a schematic diagram depicts hosting/hierarchical relationships of components within an exemplary distributed/networked supervisory process control environment. In the exemplary network, each of the multiple computing hardware nodes (PCs 100, 120, 130, 132, 134) run bootstrap software that operates as the host for subsequently loaded platform objects and a development tool referred to herein as the IDE facility. Thereafter, platform object instances are installed on the PCs. Only one platform object can be installed on each PC. The platform objects host and provide services to subsequently installed engine objects. The engines objects, in turn, potentially operate as hosts to subsequently installed HMI, device integration and application objects. The engine objects are distinguished by there differing services/hosting capabilities—and thus the type of objects they host. For example, view engines host HMI object instances while application engines host device integration objects and application objects. The various types of objects mentioned above are described further herein below.

With continued reference to FIG. 1, multiple PCs 120, 130 and 134 run an integrated design and development tool (IDE 126a-c). The IDE 126 is utilized by developers to configure and deploy components, including application objects, of a supervisory process control and manufacturing information system to designated PC nodes attached to an engineering network 119. The IDE 126 is a utility (comprising potentially multiple components) from which process control and manufacturing information applications, including application objects and engines, are defined, created and deployed to a variety of platforms/engines including, for example, the application server PC 100. Developers of a supervisory process control and manufacturing information application, through the IDE 126, carry out a wide variety of application design functions including: importing new object and template types, configuring new templates from existing templates, defining new application objects, and deploying the application objects to the host application engines (e.g., AppEngine1 on the application server PC 100). The IDE 126 is also where HMI templates, incorporating previously developed HMI applications, are defined and resulting HMI objects are instantiated and deployed to target PCs having a previously installed view engine (e.g., view engines 129a and 129b).

The IDE 126 copies operate upon a set of object templates stored in a configuration database 124 (e.g., Galaxy database) wherein the names of the defined object templates are maintained in a global name table 125. The global name table 125 facilitates binding location independent object names to location-derived handles facilitating routing messages between objects within the system depicted in FIG. 1. The configuration database 124 stores, for a configured application component, object data as well as any code or documents associated with the configured objects. The configuration database 124 stores both base object templates and derived templates for the various objects (e.g., application engines, application objects, view engines and HMI objects) depicted in FIG. 1. An exemplary visualization HMI application object derivation and instance creation scheme is depicted herein below with reference to FIG. 5. In an exemplary embodiment, the configuration database 124 comprises a MICROSOFT SQL server.

The contents of the configuration database 124 are accessed via a configuration database engine 122, also known as a galaxy repository. The configuration database engine 122 supports remote, multi-user access via the IDE 126 copies through graphically presentable check-in/check-out status descriptors for each defined object in the configuration database 124. The configuration database engine 122 also supports deployment of objects and software from a centralized source to other nodes on the system.

In the illustrative embodiment, the configuration database engine 122 is hosted by a configuration database platform 127. The configuration database platform 127 is generally the same as the other platforms installed on the PCs in the system. However, the configuration database platform 127 is assigned a unique status (and corresponding name) within the system as the platform associated with the single active configuration database 124. Thus, the disclosed system includes a single, centrally managed configuration database. In alternative embodiments, multiple copies of the contents of the database 124 are maintained (e.g., a read-only or backup copy of the contents of the database 124) on multiple nodes in the system. In the illustrative embodiment, the configuration database platform 127 and the hosted configuration database engine 122 perform the specialized functions of: data/software distribution, maintaining the global name table 125, resolving (using the name table 125) globally unique location-independent reference strings to location-derived handles (for message exchange), administering security/limited access to resources in a multi-user environment, versioning, centralized license management and importing/exporting object templates and instances.

The IDE 126 supports a variety of configuration operations involving the configuration database 124. By way of example, engineers utilize the IDE 126 to import new object templates into the configuration database 124 (via the configuration database engine 122), configure new object templates, and deploy the objects to designated PCs on the engineering network 119. As noted above, multiple copies of the IDE 126 residing on distinct network nodes are capable of accessing and editing the object definitions, including HMI application definitions and symbol definitions that are potentially incorporated into the HMI application definitions (templates).

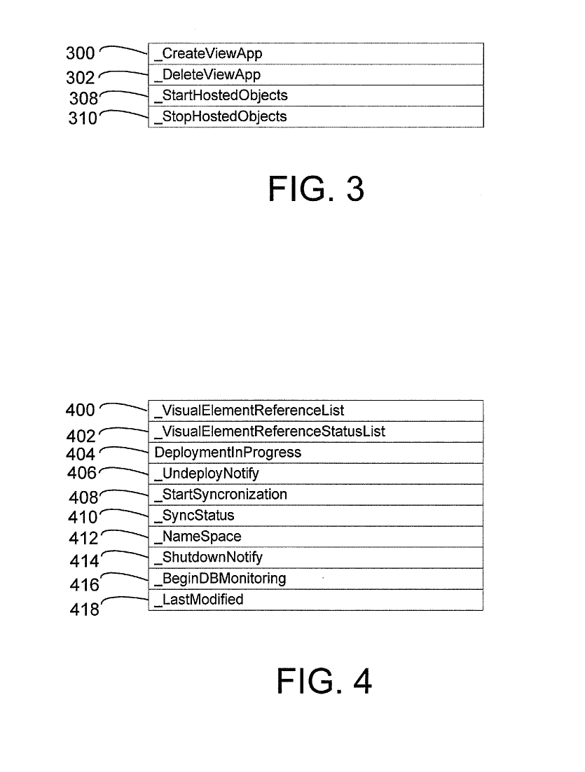

In the illustrative example, multiple HMI object instances 128a-b are deployed on multiple hardware nodes (PCs 130 and 132). The HMI object instances 128a-b, described further herein below with reference to FIG. 4, provide a graphical view/window representing a current status of a process/plant or portion thereof based upon information obtained via device integration and application objects from devices/controllers residing on a plant floor network 115. A single view engine hosts multiple distinct HMI object instances corresponding to various configured process/plant views driven by information provided by, for example a connected field device or PLC (e.g., PLC 112). In the exemplary embodiment, the HMI object instances 128a-b are hosted by view engines 129a-b (described herein below with reference to FIG. 3) in a multi-layered supervisory process control and manufacturing information system architecture. While only a single HMI object instance is shown for each view engine in FIG. 1, each view engine is capable of simultaneously hosting multiple HMI object instances.

The hosted relationship between HMI object instances 128 and corresponding view engines 129 facilitate access to certain services supported by the view engines 129. By way of example the view engines 129 support updating the hosted HMI object instances 128 independently (automatic change propagation when corresponding templates are updated). Also, the view engines 129 cache (on the associated network node) the displays associated with the HMI object instances 128.

Turning to the application server1 PC 100 on the engineering network 119, in the illustrative embodiment, data sources are presented, by way of example, in the form of application objects 105. The application objects 105 carry out a variety of functions including, representing the status of process equipment and associated application logic. The application objects carry out any of a variety of monitoring/control functions while positioned at an application level of the illustrated distributed hierarchical supervisory process control and manufacturing application architecture. Device integration objects 106a and 106b, situated at an application level as well in the hierarchy, represent data sources on a plant floor network such as PLCs (PLC1), smart field devices, and associated I/O networks (e.g., PLC1 network).

The application objects and device integration objects communicate with one another both locally (within a single personal computer) and through non-local communications with objects hosted on personal computers attached to the engineering network 119.

The application objects 105 are identified, by way of example, within the global name table 125 maintained by the configuration database 124 (e.g., the WONDERWARE Galaxy Repository)—the contents of which are made available to a developer via, for example the IDE 126a-c and HMI object instances 128 a-b that, by way of example, incorporate INTOUCH applications and their associated displays. Thus, in accordance with an embodiment of the present invention, a dynamic graphical view of a plant/process in the form of an INTOUCH application is initially created using, for example, the WINDOWMAKER utility. The entire INTOUCH application is thereafter incorporated into an HMI object template including necessary components for use in the multi-leveled application execution environment described herein. The resulting HMI object template is stored/maintained/managed in the configuration database 124. Thereafter, subsequent derived versions of the base template are maintained as children, and retain an inheritance relation, with the parent HMI object template. The original and derived templates are available for distribution via the IDE 126 to appropriate nodes on the network 119 containing a previously installed view engine (e.g. view engine 129a).

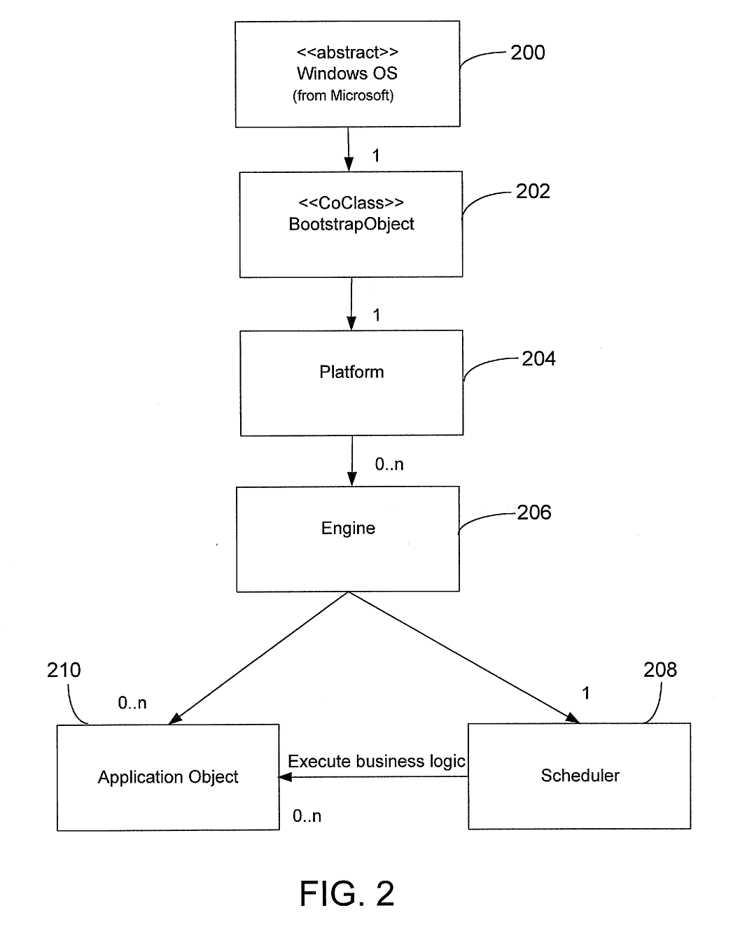

With continued reference to FIG. 1, the application server1 PC 100 executes a multi-layered supervisory process control and manufacturing information application comprising a first portion 104. The application portion 104 includes the application objects 105 and device integration objects PLC1Network 106a and PLC1 106b. The PLC1Network 106a device integration object facilitates configuring a data access server (e.g., OPC DAServer 116). The PLC1 106b device integration object, operating as an OPC client, accesses data locations within the buffers of the OPC DAServer 116. The data access server 116 and the device integration objects cooperatively import and buffer data from external process control components such as PLCs (e.g., PLC1 112) or other field devices (not depicted) on the plant floor network 115. An application engine 107 hosts both the application objects 105 and device integration objects 106a and 106b. The application engine 107, as a host, manages periodic/event driven execution of the hosted application and device-integration objects. The aforementioned components of the hierarchical hosting arrangement on the PC 100 are described herein below with reference to FIG. 2.

In the illustrative example, requests for data are submitted via the data access server 116 to retrieve data from the PLC1 112. The retrieved data is thereafter used by the HMI object instances 128a and 128b to drive graphical displays representing, for example, the status of plant floor equipment. The data buffer of the data access server 116 is accessed (directly/indirectly) by the variety of application-level objects (e.g., application objects 105, PLC1Network 106a, PLC1 106b, etc.) executing upon the personal computer 100. Examples of application objects represent data sources and logic including, by way of example, discrete devices, analog devices, field references, events/triggers, production events, etc. In an exemplary embodiment, information obtained/provided by the application-level objects 105, 106a and 106b is stored in a runtime (Historian) process information database (not shown). The data is thereafter obtained by the HMI object instances 128a-b to drive a display state of animated process graphics.

The data access server 116 is, by way of example, an OPC Server. However, those skilled in the art will readily appreciate the wide variety of custom and standardized data formats/protocols that are potentially carried out by the data access server 116. Furthermore, the exemplary application-level device integration objects 106a and 106b, through connections to the data access server 116, represent a PLC network and the operation of the PLC itself. However, the application-level objects (e.g., device integration and application objects) hosted by the application engine 107 comprise a virtually limitless spectrum of classes of executable objects that perform desired supervisory control and data acquisition/integration functions in the context of the supervisory process control and manufacturing information application.

The supervisory process control and manufacturing information system is potentially integrated with a variety of processes/plant information sources via a variety of communication channels. The exemplary system including the multi-layered application comprising portion 104 is communicatively coupled to the PLC1 112. The PLC1, in turn, receives plant equipment status information via the plant floor network 115. In a particular embodiment, the PLC 112 comprises a node on an Ethernet LAN to which the PC 100 is connected. In other embodiments, the PLC 112 is linked directly to physical communication ports on the PC 100. In still other alternative embodiments the PC 100 receives data from field I/O modules that receive, for example, analog data from field devices that operate in a distributed regulatory control system.

It is noted that the system depicted in FIG. 1 and described hereinabove is merely an example of a system including a multi-layered hierarchical architecture for a supervisory process control and manufacturing information system. It is further noted that FIG. 1 is presented as a logical view of the hosting and/or containment interrelations between installed components including software and physical computing hardware. The system disclosed herein is suitable for virtually any network topology. For example, the present invention is applicable to a system wherein both configuration utility and supervisory process control visualization applications run on a single computer system linked to a controlled process.

Turning to FIG. 2, a class diagram depicts the hierarchical hosting arrangement of layered software, comprising computer-executable instructions, associated with a computer (e.g., PC 100) executing at least a portion of a supervisory process control and manufacturing information application. The computer executes an operating system 200, such as MICROSOFT's WINDOWS at a lowest level of the hierarchy. The operating system 200, hosts a bootstrap object 202. The bootstrap object 202 is loaded onto a computer and activated in association with startup procedures executed by the operating system 200. As the host of a platform class object 204, the bootstrap object 202 must be activated before initiating operation of the platform class object 204. The bootstrap object 202 starts and stops the platform class object 204. The bootstrap object 202 also renders services utilized by the platform class object 204 to start and stop one or more engine objects 206 hosted by the platform class object 204.

The platform class object 204 is host to one or more engine objects 206. In an embodiment of the invention, the platform class object 204 represents, to the one or more engine objects 206, a computer executing a particular operating system. The platform class object 204 maintains a list of the engine objects 206 deployed on the platform class object 204, starts and stops the engine objects 206, and restarts the engine objects 206 if they crash. The platform class object 204 monitors the running state of the engine objects 206 and publishes the state information to clients. The platform class object 204 includes a system management console diagnostic utility that enables performing diagnostic and administrative tasks on the computer system executing the platform class object 204. The platform class object 204 also provides alarms to a distributed alarm subsystem.

The engine objects 206 host a set of application objects 210 that implement supervisory process control and/or manufacturing information acquisition functions associated with an application. The engine objects 206 initiate startup of all application objects 210. The engine objects 206 also schedule execution of the application objects 210 with regard to one another with the help of a scheduler object 208. Engine objects 206 register application objects 210 with the scheduler object 208 for execution. The scheduler object 208 executes application objects relative to other application objects based upon a configuration specified by a corresponding one of the engine objects 206. The engine objects 206 monitor the operation of the application objects 210 and place malfunctioning ones in a quarantined state. The engine objects 206 support check pointing by saving/restoring changes to a runtime application made by automation objects to a configuration file. The engine objects 206 maintain a name binding service that binds attribute references (e.g., tank1.value.pv) to a proper one of the application objects 210. The engine objects 206 perform similar functions with regard to hosted device integration objects.

The engine objects 206 ultimately control how execution of associated ones of the application objects 210 will occur. However, once the engine objects 206 determine execution scheduling for application objects 210, the real-time scheduling of their execution is controlled by the scheduler 208. The scheduler 208 supports an interface containing the methods RegisterAutomationObject( ) and UnregisterAutomationObject( ) enabling engine objects 206 to add/remove particular ones of the application objects to/from the scheduler 208's list of scheduled operations.

The application objects 210 include a wide variety of objects that execute business logic facilitating carrying out a particular process control operation (e.g., turning a pump on, actuating a valve), and/or information gathering/management function (e.g., raising an alarm based upon a received field device output signal value) in the context of, for example, an industrial process control system. Examples of process control (automation) application objects include analog input, discrete device, and PID loop objects. A class of the application objects 210 act upon data supplied by process control systems, such as PLCs, via device integration objects (e.g., OPC DAServer 118). The function of the device integration objects, which are also hosted by engine objects, is to provide a bridge/data path between process control/manufacturing information sources and the supervisory process control and manufacturing information application.

The application objects 210, in an exemplary embodiment, include an application interface accessed by the engine objects 206 and the scheduler 208. The engine objects 206 access the application object interface to initialize an application object, startup an application object, and shutdown an application object. The scheduler 208 uses the application object interface to initiate a scheduled execution of a corresponding application object.

Having described the relationships between bootstrap, platform, engine and application objects in an exemplary multi-layered, hierarchically arranged supervisory process control and manufacturing information application, it is noted that a similar relationship exists with regard to the objects that make up the multi-layered architecture of an HMI application (see, e.g., HMI application layered architecture on PC2 130 in FIG. 1).

Turning to FIG. 3, an exemplary set of attributes are identified for a view engine object custom primitive that augments the functionality of a basic engine to facilitate hosting a designated one of a set of available HMI object instances that have been deployed to a PC (e.g., PC 130). The content/functionality of a basic engine primitive is described in Resnick et al., U.S. application Ser. No. 10/179,668 filed on Jun. 24, 2002, for SUPERVISORY PROCESS CONTROL AND MANUFACTURING INFORMATION SYSTEM APPLICATION HAVING A LAYERED ARCHITECTURE, the contents of which are incorporated herein by reference in their entirety. View engine objects support the base engine functionality such as deployment, undeployment, startup, and shutdown. The view engine objects also support visualization application-specific functionality described further herein below. In an illustrative embodiment the view engine objects are specialized engine object types that host only HMI object instances—as opposed to application engines that are capable of hosting a variety of application-level objects including device integration objects and application objects.

The view engine (e.g., view engine 129a) hosts and schedules execution of designated HMI object instances. The view engine supports a set of runtime operations with regard to hosted HMI object instances based upon a currently occupied view engine runtime state. When a view engine is in a startup state hosted HMI objects are: initialized from a checkpoint, started by the view engine, registered with Message Exchange (or other suitable inter-object data communications service), and executed according to commands issued by a scheduler associated with the view engine. When the view engine enters an on-scan or off-scan state, the hosted HMI objects receive a notification of the view engine's new scan state. Furthermore, when a view engine enters a shutdown state, the hosted HMI objects are shutdown by their host engine.

In an exemplary embodiment, the view engine manages a list of HMI object instances deployed to it. The view engine, however, is not responsible for invoking the execution of scripts or reading and writing relevant process data associated with the HMI object instances. Instead, executing scripts and managing data subscriptions is delegated to HMI (e.g., INTOUCH) applications that are incorporated into (embedded/encapsulated within) corresponding HMI object instances. Thus, in the illustrative embodiment, an otherwise standalone HMI application, incapable of executing within the disclosed multi-layered hosting architecture depicted in FIG. 1, is incorporated into an HMI wrapper object to provide such capability. As such, standalone legacy HMI (INTOUCH) applications can be seamlessly incorporated into a system embodying the hierarchical object-based architecture described herein above with reference to FIGS. 1 and 2.

As noted above, the custom primitive for the view engine comprises a set of attributes that relate to hosting HMI application objects. The set of attributes identified in FIG. 3 (described herein below) is intended to be exemplary and is modified in accordance with alternative embodiments of the invention.

In the illustrative embodiment, it is noted that the objects (e.g., platforms, engines, application objects, etc.) are defined with a set of data points, referred to herein as “attributes”. Each attribute, in turn, potentially includes configuration and runtime handlers that process the object based upon the currently specified value of the attribute. In the exemplary embodiment, the handlers are events that are triggered and will have custom coded functionality. Configuration Set handlers are events that are triggered when the attribute is set using a configuration client (such as the IDE) and runtime set handlers are triggered when a runtime client (such as INTOUCH) sets the value of the attribute.

A _CreateViewApp attribute 300 creates a new HMI object instance when a designated HMI object template is designated for deployment to a view engine. A reference to the new HMI object instance is added to a list of deployed HMI objects that are managed by the view engine.

A _DeleteViewApp attribute 302 removes a previously deployed HMI object from a set of HMI objects presently deployed on the view engine. A corresponding reference to the HMI object is deleted from the list of deployed HMI objects on the view engine.

A _StartHostedObjects attribute 308 commences running all deployed HMI objects on the view engine. The initial state of the HMI objects is based upon values extracted from the checkpoint persistent storage.

A _StopHostedObjects attribute 310 commences shutting down all HMI object instances that are currently hosted by the view engine.

Turning to FIG. 4, attention is directed to an exemplary set of attributes of a custom primitive for an HMI application object. The HMI application object carries out functionality associated with providing a graphical view portion of a distributed supervisory process control and manufacturing information application. The HMI application object, executing on a host view engine in the above-described hierarchical runtime environment, manages the checkin/out, editing, deployment, and runtime attribute monitoring of an incorporated HMI (INTOUCH) application that, in turn, provides a dynamic graphical view of a plant/process. The graphical state of the HMI application is driven by live data provided, for example, by plant equipment sensors, monitors, and controllers. Such information is extracted from the plant floor network via the device integration and application objects executing on an application engine (described herein above with reference to FIG. 1). The HMI object also supports referencing tags (Message Exchange) on application server hosted application-level objects through which dynamic process data is passed to the HMI application incorporated therein.

In the illustrative example HMI (e.g., INTOUCH) applications that execute scripts and manage data subscriptions are incorporated into (embedded/encapsulated within) corresponding HMI application object templates and instances. Thus, in the illustrative embodiment, an otherwise standalone HMI application, incapable of executing within the disclosed multi-layered hosting architecture depicted in FIG. 1, is incorporated into an HMI application wrapper object that facilitates integrating (managing, running, etc.) the HMI application within systems that adopt the aforementioned hosted hierarchical runtime environment. As such, standalone legacy HMI (INTOUCH) applications can be seamlessly incorporated into a system embodying the hierarchical object-based architecture described herein above with reference to FIGS. 1 and 2.

The aforementioned HMI wrapper object comprises a custom primitive including a set of attributes that relate to execution of an HMI application within the hosting environment supported by a view engine. The set of attributes identified in FIG. 4 (described herein below) is intended to be exemplary and differs in accordance with alternative embodiments of the invention.

A _VisualElementReferenceList attribute 400 contains a listing of all visual elements (e.g., symbols) assigned to an HMI application object.

A _VisualElementReferenceStatusList attribute 402 specifies a current status of each symbol assigned to an HMI application object. The status can be used to convey a variety of statuses for symbols contained within the HMI application object including, for example, to show when a symbol has been deleted from the HMI application object.

A DeploymentInProgress attribute 404 is set to true while HMI application files, associated with an HMI application object, are being synchronized with the configuration database 124.

An _UndeployNotify attribute 406 specifies whether an HMI application object can be undeployed.

A _StartSyncronization attribute 408 is set to true to inform an HMI application object that it should begin transferring HMI application files for the application associated with HMI application object to a node where the HMI application object is deployed.

A _SyncStatus attribute 410 indicates the status of the transfer of an HMI application to the node where an associated HMI application is deployed.

A _NameSpace attribute 412 contains information regarding parameter tags that are part of an HMI application associated with an HMI application object. The _NameSpace attribute 412 is used to support browsing of the tags of the HMI application within an attribute browser.

A _ShutdownNotify attribute 414 is written to just prior to shutdown of an associated HMI application editor to ensure that an asynchronous method in progress completes before the editory process is allowed to shut down.

A _BeginDBMonitoring attribute 416 is written to when an HMI application editor starts up to ensure the HMI application object is loaded and validated properly when the edit session begins.

A LastModified attribute 418 specifies the last time the HMI application's version number was modified.

The HMI application object, by way of example, exhibits a runtime behavior summarized in the description that follows. When the HMI application object is executed (under the direction of a host view engine), logic incorporated into the HMI application object determines whether an HMI application incorporated within the HMI application object needs to be transferred from the configuration database 124. If a transfer needs to be initiated, then the transfer is started on the next scan of the HMI object by the view engine.

Synchronization can occur at any time after startup of the HMI application object. The HMI application object initiates synchronization of an HMI application with a source application. If pending synchronization operations are complete then the HMI object sets an attribute within the configuration database 124 to indicate that the transfer is complete. In accordance with an embodiment of the present invention, the synchronization application can comprise updating an encapsulated HMI application or individual symbol objects incorporated into the HMI application that have been updated within the configuration database 124. In the case of updating an HMI application, only application files within the configuration database 124 that differ from files currently on a node having an HMI application object instance incorporating the HMI application are transferred from the configuration database 124.

Turning to FIG. 5, an exemplary visualization HMI application object derivation and instance creation scheme is depicted which facilitates central management of HMI application object instances distributed to potentially many nodes on a network. Such central management includes updating previously deployed HMI application objects in response to changes to configurations of associated HMI application templates, including symbol objects incorporated therein. The set of HMI application and symbol templates are stored, by way of example, in a centralized configuration database such as configuration database 124.

In the illustrative embodiment a base HMI application object template 500 provides a framework from which a set of derived HMI application object templates 502a-n are derived and stored within the database 124. The base HMI application object template 500 provides base executable code and data for managing an HMI application associated with (encapsulated within) an HMI object instance. The application object templates 502a-n, derived from the base HMI application object template 500, are associated with particular HMI applications (e.g., INTOUCH applications). The HMI applications are encapsulated within the HMI application object templates which provide a reusable copy of each of the HMI applications within a system comprising multiple HMI nodes. In a particular exemplary embodiment, each one of the derived HMI application object templates 502a-n are associated with a particular INTOUCH application defined using an HMI application editor utility that executes independently of the IDE configuration environment.

Development of the HMI application templates and their management (including creating and deploying instances) is handled by the IDE components that potentially reside on multiple nodes of a network (see, e.g., FIG. 1). Therefore, in an illustrative embodiment a graphical interface enumerating the HMI object templates in a variety of views (e.g., derivation) visually displays the status of each object template (e.g., checked in/out—for editing, deployed/undeployed, changed (after editing)). Providing visual status indicators enables developers, using the IDE, to quickly determine a particular HMI application template's status in an environment where multiple users can access such templates for reviewing, editing and deployment.

Encapsulating HMI applications within HMI application templates facilitates exploiting the various development views supported by the IDE 126. The views include, for example, a Model view (representing the physical layout of a plant floor/process), a Deployment view (the location on the network and hosted relationships), a Derivation view (representing the hierarchical parent-child object template relationships). Such views supported by the IDE 126 are described in-depth in Resnick et al., U.S. application Ser. No. 10/179,668 filed on Jun. 24, 2002, for SUPERVISORY PROCESS CONTROL AND MANUFACTURING INFORMATION SYSTEM APPLICATION HAVING A LAYERED ARCHITECTURE, the contents of which are incorporated herein by reference in their entirety including the contents and teachings of any references identified/contained therein.

In an exemplary embodiment, HMI application object instances 504 (e.g., HMI application object instances 504a-m) are created from the derived application object templates 502 (e.g., HMI application object template 502a) and deployed to designated view engines. In an exemplary embodiment, a developer defines the HMI application object template 502a ($UserDefinedInTouchApp1) and then invokes a deployment utility to create and deploy m instances of the HMI application object to m nodes on a network including a plurality of monitor stations that potentially need the HMI application.

The illustrative embodiment also supports independent development/editing of symbols (as symbol templates) that are thereafter incorporated into HMI application object templates. A base symbol object template 510 ($Symbol) provides a framework from which a set of derived symbol object templates 512a-x are defined and stored within the database 124. The base symbol object template 510 provides base executable code and data for symbols embedded by reference within particular ones of the application object templates 502 (e.g., HMI application object template 502n).

It is noted that while FIG. 5a depicts a standalone template for a symbol, the system supports standalone symbol templates, symbol templates hosted by other object templates (e.g., an application object template), and symbols hosted by an object instance.

In the illustrative example, the symbol templates themselves are container object templates for other symbols derived from the base symbol template 510. With reference to FIG. 5, a defined symbol object template, such as symbol template 512x, is embeddable within another symbol template (e.g., symbol template 512a). The symbol template 512 (e.g., symbol template 512a) is also embeddable, by reference, in an HMI application template 502 (e.g., HMI application template 502n). References within HMI application templates to embedded symbol templates are used prior to deployment of HMI application object instances. Furthermore, lists are maintained in the configuration database 124 that identify each HMI application template and symbol template within which each symbol template is embedded. Such lists facilitate propagating changes to symbol templates to all HMI application and symbol templates within which the changed symbol templates are embedded.

In an exemplary embodiment the update mechanism uses a cascading update mechanism to update all affected symbol and HMI application templates within which a changed template is embedded. Thus notification of a change to a symbol template is propagated to a first set of templates that directly embed the symbol template. Thereafter, to the extent those templates are embedded within other templates or have child derived templates, the change notification and update mechanism propagates through to those affected templates.

In an exemplary embodiment, symbol templates are embedded within HMI applications. The symbol templates and HMI application templates are maintained within the configuration database 124 accessible to the IDE and have associated status designations (e.g., checked in/out, changed, etc.) facilitating coordinating editing among multiple users and propagating changes to templates within which changed symbol templates reside.

Turning to FIG. 5b, a set of stages are presented that summarize various points of interest in the lifetime of a symbol template. Initially at stage 520 a user derives a symbol template 512x from the base symbol template 510 and the symbol template 512x is added to a graphics toolbox maintained by the configuration database 124.

Thereafter at stage 525, while editing HMI applications, the symbol template 512x is selected from a set of object templates maintained in the configuration database 124 and listed using a browser tool associated with the configuration database 124. The symbol template is selected either directly from a graphic toolbox or indirectly selecting an object (e.g., an application object) with which the symbol template 512x is associated.

When the symbol template 512x is embedded in an HMI application, only a reference to the symbol template is persisted. When the HMI application is loaded/deployed, the symbol graphic definition is retrieved from the configuration database 124. The version inserted into a deployed HMI application is the last “checked-in” version of other users or the last saved version of a current user requesting the copy of the definition. As noted above with reference to FIG. 4, an HMI application template maintains a listing of all the embedded symbols in its _VisualElementReferenceList attribute 400. The _VisualElementReferenceList attribute 400 is used by the system for propagation, deployment and other purposes.

After the symbol template 512x has been embedded within an HMI application (which is in turn encapsulated in an HMI application template), at stage 530 the symbol template 512x is edited to render a changed symbol template 512x′. Examples of editing operations that are performed on the symbol template 512x include: Override Symbol Text Strings (Substitute Strings), Override Symbol Data References (Substitute Tags), Override Symbol Graphic Attributes, Apply Animations, Resize, Move, Delete, Cut, Copy, Paste, Duplicate, Alignments, Distribution, Make Cell (added as part of a cell), Send to back, Bring to front, etc. The changed symbol template 512x′ is thereafter checked in to the configuration database 124.

In an exemplary embodiment, the IDE supports a cross-reference capability that provides, for each object template, two sets of references—a listing of “who references me” and a listing of “who do I reference”. The “who do I reference” reference set identifies any embedded symbols in the symbol or HMI application template. The “who references me” reference set shows any HMI applications or other symbol templates within which the symbol template is embedded. This functionality of the IDE leverages the _VisualElementReferenceList attribute 400 on the HMI template to create/update the cross references for the HMI application templates, for example, when symbol templates or HMI application templates are checked in after adding new symbols.

Thereafter, at stage 535, using the “who references me” reference list, the changes to the symbol template are propagated (through potentially cascading symbol templates) to each HMI application template containing (either directly or through one or more other symbol templates within which the symbol is embedded) the changed symbol template. In an exemplary embodiment, when a changed symbol is “checked in” to the configuration database 124, the object management structure associated with the configuration database 124 marks any deployed HMI application object instances affected by the change as “pending changes”. Thereafter, a remote re-deployment mechanism is utilized to update each of the affected instances. However, only changed portions of the deployed instances are transferred to the runtime node containing an affected HMI application instance.

### Propagating Changes to HMI Instances

With continued reference to FIG. 5, the individually defined HMI application object templates 502 (e.g., HMI application template 502n) and symbol templates 512 (e.g., symbol template 512a) support propagation of changes to templates to corresponding HMI application object instances 504. Thus, any changes to HMI application object templates 502 or symbol templates 512 embedded into the HMI application object templates are propagated to any HMI application object instances containing a reference to the changed HMI application/symbol templates. To facilitate such propagation, the database 124 maintains a listing of all object instances containing any HMI application/symbol templates. Thus, when a particular HMI application/symbol template changes, all view engines hosting deployed instances of HMI application objects affected by the change are notified by the configuration database engine 122. Thereafter, the new versions of the changed objects (or changed portion thereof) are redeployed and restarted on the proper view engines.

### Centralized Management of HMI Applications Within The IDE Environment

The following summarizes an exemplary management scenario for creating and maintaining HMI application objects in the above-described environment including the IDE 126. In the illustrative example, an HMI application is developed outside the IDE 126. Thereafter, the HMI application is encapsulated within an HMI application template derived from the base HMI application template 500 via a copy of the IDE 126 running on potentially any node in the system (see, e.g., FIG. 1).

Encapsulating the HMI application within an HMI application template and maintaining a reference to the HMI application within the HMI template facilitates coordinated editing of the HMI application via the IDE which supports editing of objects within the database 124 from remotely connected/networked nodes running a copy of the IDE 126x. Furthermore, accessing the HMI application via its HMI application template facilitates applying the concurrent access rules/status infrastructure (e.g., checked in/out, deployed/undeployed, and changed) supported by the configuration database 124 and its associated platform/engine functionality described herein above.

In an exemplary embodiment, an HMI application is represented within the IDE 126 as a specific type of application object template referred to herein as an HMI application object template. The HMI application object template contains a reference to an HMI application and specific information about the behavior of the HMI application, but the HMI application object template does not store the data of the HMI application within the configuration database 124. Instead, the HMI application data is maintained in a file repository directory associated with the template in the standard format defined by the HMI application (thus preserving the format of the source HMI application). Since there are implications of associating an HMI application object template with an HMI application the template is restricted in what a user can and cannot do with it. The same is true of instances created from an HMI application object template. The user cannot change any HMI-specific attributes of the base HMI application object template 500. All other attributes on the base template follow the same rules as other object templates provided via the IDE 126. Users derive an HMI object template (e.g., HMI template 502a) from the base HMI application object template 500 to set HMI application-specific attributes. The base template 500 does not support direct creation of HMI application object instances (e.g., application instance 504a). Derived HMI application object templates and their object instances are made up of two separate data definitions: an object definition within the system framework described herein above, and an HMI application.

A set of functions supported during lifetime management of HMI application templates are depicted with reference to FIG. 6. A derive function 600 enables a user to define an HMI application object template associated with (encapsulating) a particular HMI application. Through the derive function 600, a user associates an HMI application (standalone) with a derived template. The exemplary embodiment supports multiple ways of associating an HMI application with a derived template. Two examples of operations supported by the IDE 126 for associating an HMI application with an HMI application object template include: create and import. These operations are only available to the HMI template and cannot be performed on an instance of the HMI application object template. In contrast to the HMI application templates/objects, HMI applications that are associated with an HMI template are not stored in the database 124. Instead, the HMI applications are stored in a directory under a file repository (not shown in FIG. 1). Furthermore, the HMI application is separately edited and its contents processed using an HMI application development tool (e.g., WINDOWMAKER) that is capable of operating independently of the IDE 126.

When a user launches the HMI application development tool, a user is prompted to create a new HMI application or import an existing application. Importing an existing application to an HMI application object template involves specifying the location of an existing HMI application within a file system directory. The “import” operation referenced herein is, in practice, a copy and associate operation. Thus, when a user imports an HMI application for the purpose of creating a derived HMI application object template, the HMI application object template receives a copy of the entire contents of the specified HMI application, including sub-directories, that are then stored in a file repository associated with the IDE 126. Once an association between an HMI application object template and an HMI application has been created, the association is permanent and cannot be altered. Creating a new association to a different HMI application requires deleting the HMI application template from the configuration database 124 as well as all deployed instances of the template. In a particular embodiment, certain restrictions are placed upon importing HMI applications. For example, the import operation is not allowed on applications that are presently associated with another HMI application object template, applications that have been deployed along with an HMI application object template, and applications that have been exported from an HMI application object template.

A delete operation 602 enables a user to delete an HMI application object template from the configuration database 124 through the IDE 126. When a user deletes an HMI application object template, the template and the HMI application directory associated with that template are deleted completely. Deleting an HMI template is subject to rules associated with concurrent usage by others of either the template or HMI object instances created from the template. The copied (source) HMI applications themselves are unaffected by the deletion of a template.

A rename operation 604 is supported with regard to an HMI application template or instance thereof. Renaming an HMI application object instance does not impact an associated HMI application.

An export HMI template operation 606 is supported with regard to HMI application object templates and instances. When exporting an HMI application object template for import into another configured system (referred to herein as a “galaxy”), a package file is created that includes all necessary data and files for both the HMI application object template and its associated HMI application. In an exemplary embodiment, symbols are not included within the package. However, in alternative embodiments any symbols embedded within an associated HMI application are also included in the export package.

An export HMI application operation 607 is supported with regard to the encapsulated HMI application contained within the HMI application template. Exporting an HMI application from an HMI template stored in the configuration database 124 renders the HMI application in its former standalone environment. Users who only want to add new HMI technology graphics to a standalone HMI application can do so by importing the standalone HMI application via the derive function 600, but will not be able to leverage the deploy functionality (that requires the ARCHESTRA infrastructure). In order to move an HMI application to a destination machine a user invokes an export operation that is available when managing the HMI application template. When the export operation is invoked, the user is prompted to enter a destination directory path. Once the user performs this operation and acknowledges the operation the entire encapsulated HMI application is placed in the provided path including: all HMI application windows, a tag name Dictionary, previous generation symbols, previous generation localization data, and embedded new technology graphics. Any new technology (ARCHESTRA) graphics are handled using the viewer utility of the previous HMI technology (INTOUCH) augmented with added components for accommodating the new graphics technology and embedded new technology graphic data. The aforementioned import/export sequence enables users to incorporate new technology graphics without having to migrate completely to the platform of the new HMI technology.

The exported HMI application can now be opened in an editor facility enhanced through added components to allow edits to be preformed in the field on the disconnected/standalone HMI application. The enhanced editor facility allows editing both the previous and new HMI technology graphics. The degree of editing on the new technology graphics is determined by the enhancements provided by the added components and include, for example: Resize, Delete, Configure Animations, Move, Duplicate, and Clipboard Operations (cut, copy, and paste).

An import operation 608 is supported with regard to HMI application object templates and instances. When importing the HMI application object template the template container specific files and data are imported into the configuration database 124. The HMI application is extracted from the package file used to import the HMI application template and copied to a file repository. If an imported HMI application object overwrites an existing HMI application object with an existing associated HMI application, all data for all versions of the prior existing HMI application are deleted.

A backup operation 610 and a restore operation 612 are supported with regard to HMI application object templates. When a system that contains a fully configured HMI application object template is backed up all associated HMI application data is included in the backup file. Subsequent restoration of the backup file places the associated HMI application object template data in the file repository for the restored system.

Version management 614 is supported such that multiple prior versions of an HMI application object are maintained within the configuration database 124. With regard to non-HMI object templates, all object configuration data is stored in the configuration database 124. However, in an exemplary embodiment, the HMI application portion of an HMI application object template is stored outside the configuration database 124 (the template container data is however stored in the database 124). The multiple versions of object templates stored within the database 124 comprise: checked-in, checked-out, and deployed versions. Corresponding versions of the associated HMI applications are stored outside the configuration database 124 in a file repository.

Version management of an HMI application object template exhibits the following behaviors with regard to checked-in, checked-out, and deployed versions. The checked-in version of the template represents a most current configuration version of the associated HMI application. Any time an HMI application object template is checked-out the checked-in version is used as the starting point for user editing. Any time an instance is deployed, the checked-in version is the version sent to a designated destination platform. Any time a checked-out HMI application object template is checked-in the checked-out version of the template is copied to the checked in version. The user never directly edits a checked-in version of an HMI application object template.

The following points describe the checked-out version behavior of an HMI application object template. The checked-out version of the HMI application object template represents the copy of the HMI application template that is undergoing changes by a user who has checked it out. Any time a user checks-out an HMI application object template the checked-out version is a copy of the current checked-in version (prior to the user making any changes). When a user checks-in the HMI application object template the checked-in version is overwritten with the checked-out version. The user directly edits the checked out version of the HMI application object template. HMI application object instances are always locked in the template. There is no checked-out status for an HMI application instance. An “Undo Check-out” operation on a checked out HMI application causes the current checked-out version to be discarded and the currently checked-in version is used for subsequent checking-out and editing operations.

The following points describe a deployed version of an HMI application object template. The deployed version of the HMI application object template and associated HMI application represent the version that is currently found on a target platform. When an HMI application object template is deployed the associated checked-in version of the HMI application is copied to a designated target platform and the current deployed version is over-written with the checked-in version in the database 124. A user is not provided direct edit access to a deployed version. HMI application object templates are not deployed and will not have deployed versions. The deployed version of the HMI application associated with an HMI application object template should only contain the information that is essential for the HMI application to run successfully. Any files that represent back-ups or configuration only files should not be included in the deployed copy of the HMI application. This will minimize the amount of data that has to be transferred to a target PC during deployment.

Attention is now directed to configuring an HMI application object template including an embedded HMI application developed in a separate HMI application design tool (e.g., Wonderware's WindowMaker HMI application editor). The following describe the combined functionality of the IDE 126 (installed on potentially multiple nodes remote from a node containing the database 124) and an HMI application editor (e.g., WindowMaker) for configuring an HMI application object template.

The IDE 126 supports the following operations/workflow on an HMI application object template object. A user initially launches an HMI application editor to edit an HMI application associated with an HMI application object template. By way of example, the HMI application editor runs on a separate process from the IDE 126. However, in an exemplary embodiment, when closing the IDE 126, if the HMI application editor is open, a user is prompted to save any changes made in the HMI application editor. The IDE 126 is closed only after closing the HMI application editor. In an embodiment that incorporates secure login, the HMI application editor is closed before changing to another logged on user. Editing an HMI application object template is prevented while an associated HMI application is being edited.

As noted in FIG. 5 described herein above, multiple HMI application object templates are potentially defined and stored in the database 124. Also, multiple copies of the IDE 126x are capable of operating simultaneously on the same or different (remote) node as the node containing the database 124. The IDE 126 utilizes object template edit session management to track an HMI application template having an HMI application being edited by an HMI editor. Thus, in an illustrative embodiment, the HMI application editor (e.g., WindowMaker) will not open a particular HMI application object template for editing under certain circumstances such as: the HMI application object template is checked-out to another, and an HMI application encapsulated within a selected HMI application template is defined in the derivation hierarchy, but not within the same instance or template where the HMI application is being launched. However, the HMI editor will be allowed to open in read-only mode in such circumstances.

Configuring HMI application node properties for an HMI application object template are described below in accordance with an exemplary embodiment. HMI application node properties, by way of example, apply to an entire machine running an HMI application and are therefore not directly edited from the IDE 126 for an HMI application object template. The HMI application node information is instead managed from an HMI application manager on the particular node.

HMI application editor behaviors for configuring an HMI application object template are described below for an exemplary embodiment. An HMI application object template has two sets of configuration data: (1) HMI application object template attributes, and (2) associated HMI application data. HMI application data is configured using the HMI application editor (e.g., WindowMaker) and persisted to files in a location in a file repository for the configured system (galaxy). An HMI application object template is associated with an HMI application before configuring opening the HMI application template (and its associated HMI application) in the HMI editor. The HMI editor, by way of example, in addition to supporting the editing of an HMI application also supports editing HMI application object attributes (such as the Description for the template).

From the IDE 126 point of view, the HMI application editor is an object editor for HMI application objects. But the HMI application editor is not a regular object editor because its primary function is to define/configure HMI applications that are encapsulated within HMI application object templates/instances. By way of example, the HMI application editor includes the following functionalities. The HMI application editor does not have a “Save and Close” command. The user closes the editor and is prompted to save any outstanding edits. A “keep checked-out” option is set to false when an HMI application object template is checked-out implicitly by the system. If the HMI application object template was checked-out explicitly then the option is set to true. When closing the HMI application editor, either through Save and Close or through Close, the keep checked-out option determines whether to perform implicit check-in. The implicit check-in happens only if the option is set to false.

The following behaviors apply, in an exemplary embodiment, to closing the HMI application editor. Implicit check-in is performed for the HMI application object template if the keep checked-out option is set to false. Implicit undo check-out is performed if the keep checked-out option is set to false and nothing changed.

In an illustrative embodiment, an HMI application editor also accesses/edits attributes of HMI application objects. The object specific data of an HMI application object (as opposed to the HMI application data) is edited via the HMI application editor. The HMI application editor provides a user interface (e.g., a list of attributes, descriptions, and current values) to configure these attributes of HMI application objects.

The following summarizes functionality supporting the definition of graphics associated with an HMI application object template. In an exemplary embodiment, all supporting graphics are deployed to a target node as part of a deployed HMI application object. When objects, graphics and other supporting components are deployed to a target node as part of an HMI application objectc, they represent a snap-shot in time of the configuration database 124 (and file repository of HMI applications) at the time the deployment occurred. In an exemplary embodiment, the contents of the database 124 and the file repository are allowed to change after deploying objects that are potentially affected by such changes.

In an exemplary embodiment reference lists are used to ensure that all required graphics for a deployed HMI application object are copied to a target node. Two types of reference lists are supported: implicit and explicit. With regard to implicit references, when a symbol is embedded in another graphic or a window is used in an animation an internal reference list is updated in the component to ensure that when the component is deployed all of the required supporting graphics are included. This is referred to herein as “implicit referencing”. By way of example, implicit reference lists are automatically created (without user intervention). Since each defined graphical view and embedded symbol in an HMI application object template/instance comprises an implicit reference list there are cascading affects on propagation and deployment when referencing a view or symbol which has its own references.

Explicit reference lists are utilized in cases where an implicit reference is not automatically generated. In some instances the system is incapable of determining a set of references to graphical views/symbols for a graphical component of an HMI application object/template. For example, a script on a button which invokes an animation based on information determined at run-time would not result in any implicit references being generated. Because the run-time displaying of views associated with an HMI application object are based solely upon what is currently deployed, the system would not be able to load the requested window unless it had already been implicitly referenced in some other animation.

Yet another aspect of configuring and accessing a configuration of an HMI application object template/instance encapsulating an HMI application is the viewing of tags associated with the encapsulated HMI application via the IDE 126. In an exemplary embodiment, an attribute browser within the IDE 126 supports browsing tags of an HMI application associated with (encapsulated within) an HMI application object template/instance. The browser also supports browsing attributes that belong to the namespace of the HMI application object template/instance itself.

When an HMI application object instance is selected by an attribute browser utility of the IDE 126, a list control is generated that includes an HMI application tagname column and a data type column. The tagname column, by way of example, contains the name of an HMI application tag. The list control will provide the attribute name for any entry corresponding to an attribute on the HMI application object template/instance. The data type column specifies the data type of an HMI application tag for an entry on the list.

The browser incorporates refresh capabilities that facilitate synchronizing deployed instances of a changed HMI application object template. If an HMI application template is checked out for editing via the IDE 126, and the user updates/adds a new tag to an HMI application encapsulated within the HMI application template, then the user can browse the attributes of the HMI application object via the attribute browser and see the change once the user saves the encapsulated HMI application. Furthermore, users that don't have the HMI application object checked out will see the tags associated with the currently checked in version of the HMI application object template. Also, the attribute browser of the IDE 126 will display any changes to a HMI application tag database associated with the encapsulated HMI application when the tag database is refreshed. Possible changes to the tag database are caused by addition and deletion of tags from the tag database either manually via an HMI application editor or through bulk import of tags, and by editing an existing tag and changing a data type or name. Encapsulating the HMI application within an HMI application object template maintained within the configuration database 126 thus enables, in an exemplary embodiment, management of tags associated with an HMI application via the IDE 126x copies executing on any of potentially many nodes in a system (see, e.g., FIG. 1).

Having described configuration-related aspects of a system that supports encapsulation and central management of HMI applications, attention is directed to deployment and runtime behaviors of such systems. With regard to deploying an HMI application object instance to a node on a network such as the one depicted in FIG. 1, a view engine 129 is deployed prior to deploying any HMI application objects on a node. A single platform is capable of simultaneously hosting multiple view engines 129, and multiple HMI application objects 128 are potentially assigned to a single view engine 129.

During deployment of an HMI application object instance (and any embedded symbol object instances), all data and files that are required on the target node by the deployed HMI application object and encapsulated HMI application are copied to the target node on an as needed basis. Only those files that are missing or have changed since the last deployment are copied to the target node. Deployment operations of HMI application object instances utilize checked in versions of components.

Deployment of an HMI application object instance includes deploying the container HMI application object instance and data defining an encapsulated HMI application. By way of example, the HMI application data consists of files and folders in a file repository directory associated with the HMI application. If the HMI application object was previously deployed it must be assumed that the previously deployed application is currently in use. As will be explained below, users have several options for handling the previous deployment of HMI objects to a target node based upon a “change mode” designation for an HMI object. An “ignore changes” change mode facilitates manual management of changes in an HMI application using tags and script functions to implement a custom solution. A discrete (Boolean) HMI application system tag named $ApplicationChanged is set to true when a new application is available. The following script functions are used to accept the new application:

1. RestartWindowViewer( )—causes a viewer associated with the encapsulated HMI application to close immediately and then automatically restart. At the time the encapsulated HMI application restarts the latest version of the HMI application deployed to a node will be loaded, this will also set the $ApplicationChanged tag associated with the HMI application to false. If the HMI application viewer is closed and reopened without using the RestartWindowViewer( ) function, then application that was previously in use is reloaded and the newer application will not be loaded (the $ApplicationChanged system tag will remain true). The RestartWindowViewer( ) script function will function as described here for all change modes described herein.

2. ReloadWindowViewer( )—causes the viewer associated with the encapsulated HMI application to load the latest version of the application that has been deployed to the node. The ReloadWindowView( ) function differs from the RestartWindowViewer( ) function in that it will only restart the HMI application viewer if the application change is one that cannot be loaded without a complete restart. The ReloadWindowViewer( ) script function functions as described here for all change modes described herein.

A “restart viewer” change mode causes the HMI application viewer to automatically restart whenever a new HMI application version is deployed to the target node. Upon restarting, the latest HMI application version deployed to the node is loaded into HMI application viewer.

A “prompt user to restart viewer” change mode causes prompting of a user to indicate whether the user would like to restart the HMI application viewer and accept the new HMI application when a new HMI application has been deployed to the target node. If the user chooses not to restart the HMI application viewer, a reminder is issued after expiration of a reminder period. Upon restarting the latest HMI application deployed to that node will be loaded into WindowViewer.

A “load changes into viewer” change mode causes the HMI application viewer to load the latest HMI application deployed to the node without restarting the viewer. An associated configuration setting determines how changes that require restarting will be handled:

1. “Prompt User For Restart”—causes the viewer to prompt the user with regard to whether to restart the viewer to accept the new application. If the user chooses not to restart the viewer he will be reminded again after a reminder interval has expired. Upon restarting, the latest HMI application deployed to that node will be loaded into the viewer.

2. “Automatically Restart” —causes the viewer to restart automatically to apply a change. If the viewer does not need to be restarted to apply the change, then the new application will be loaded with no interruption to the running process. Upon restarting the viewer, the latest deployed to that node will be loaded into WindowViewer.

A “prompt user to load changes into viewer” change mode causes the HMI application viewer to notify a user that a new version of the HMI application is available. If the user chooses not to accept the changed HMI application he will be reminded again after the reminder interval has expired. If the HMI application viewer needs to be restarted to apply the change, then the operator will be notified of this and when accepted the viewer will restart automatically. If the does not need to be restarted to apply the change, then when the user accepts the new application it will be loaded with no interruption to the running process.

Attention is now directed to deploying an HMI application object instance that encapsulates an HMI application discussed herein above. Deploying an HMI object instance uses standard deployment mechanisms supported by the system for all objects executing on engines. All instance data of the HMI application object is deployed synchronously along with the instance of the HMI application object. If the HMI object instance is already deployed and a “Deploy Changes” operation is invoked on that object, then a check will be made to determine whether the HMI container object itself has any changes that require it to be deployed. If it does not have any such changes (i.e., all changes are in the encapsulated HMI application), then the HMI object will not be undeployed and then deployed, and only the changed HMI application is delivered.

In an exemplary embodiment undeploying an HMI application object instance via the IDE 126, or other suitable configuration utility, removes both the HMI wrapper object as well as the associated/encapsulated HMI application. If the HMI application is currently being utilized by a running HMI application (e.g., INTOUCH) viewer, then the undeploy operation fails (is not carried out on the node). Once the undeploy operation completes successfully the HMI application will be incapable of running. The actual files remain until the Platform is undeployed (due to deploy design) but the HMI application is prevented from running.

In view of the many possible embodiments to which the principles of this disclosed system may be applied, it should be recognized that the embodiments described herein with respect to the drawing figures are meant to be illustrative only and should not be taken as limiting the scope of invention. For example, those of skill in the art will recognize that some elements of the illustrated embodiments shown in software, stored on computer-readable media in the form of computer executable instructions, may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

What is claimed is:

1. A system for facilitating centralized management of human machine interface (HMI) components distributable across multiple nodes of the system, the system comprising:
a centralized configuration storage for managing a set of HMI templates deployable to a set of remote nodes including HMI facilities that execute instances of HMI objects instantiated from the HMI templates;
an HMI application import utility that encapsulates HMI applications to render the HMI templates; and
a remote deployment facility for deploying instances of the HMI templates to the set of remote nodes.
